(19) United States
(12) Patent Application Publication
(10) Pub. No.: US 2020/0287438 A1
(43) Pub. Date: Sep. 10, 2020

(54) BRUSH HOLDING ASSEMBLY FOR AN EXCITED-ROTOR ELECTRIC MACHINE

(71) Applicant: ELDOR CORPORATION S.P.A., Orsenigo (Como) (IT)

(72) Inventors: Pasquale FORTE, Orsenigo (Como) (IT); Giandomenico ALBERTINI, Orsenigo (Como) (IT); Fabio MARIGLIANO, Orsenigo (Como) (IT)

(21) Appl. No.: 16/645,242

(22) PCT Filed: Sep. 14, 2018
(86) PCT No.: PCT/IB2018/057038

§ 371 Date: Mar. 6, 2020

(30) Foreign Application Priority Data
Sep. 15, 2017 (IT) 102017000103738

(51) Int. Cl. H02K 5/14; H01R 39/38; H01R 39/41; H02K 15/14

(52) U.S. Cl. CPC H02K 5/141; H01R 39/383; H02K 15/14; H01R 39/381; H01R 39/41

(57) ABSTRACT

A brush holding assembly for an excited-rotor electric machine includes a casing including two ducts flanking each other and developing along a direction between first and second ends, at least two brushes each housed capable of sliding in a respective duct and projecting outwardly to the second end and a connecting member arranged to connect with an electric current generation unit associated with said casing at the first end. The assembly also includes presser members associated with the brushes and configured to push the brushes towards the second end to keep them pressed on the respective tracks of a rotating manifold of a rotor and at least two conductive elements developing along the direction, each operatively interposed between a respective brush and the connecting member and configured to deform along the direction in order to follow the movement of the brush imparted by the presser members.

The present invention object is a brush holding assembly device for an excited-rotor electric machine.

The present invention therefore has particular application in the making of excited-rotor electric machines, preferably for the use of automotive traction.

These types of electric machines, in fact, have a rotor and a stator both fed by a current generator. In order to allow the connection between the generator and the rotor, it is usually provided the use of a manifold engagement.

Generally, in fact, a sleeve (called slip ring) is fitted on the rotor rotation shaft on which two circumferential conductive tracks are fixed parallel to each other and connected in turn by copper wires to the rotor windings.

On the machine casing there is a housing for a brush holding assembly, inside which there are at least two brushes (or abutment elements) which are placed in sliding contact with the tracks in order to transmit the current.

Disadvantageously, the presence of a sliding contact determines that, over time, the brushes may wear out, reducing the contact pressure on the tracks and, therefore, creating reliability problems for the machine.

The aim of the present invention is to make available a brush rigging for an excited-rotor electric machine capable of overcoming the drawbacks of the aforementioned prior art.

More precisely, the aim of the present invention is to make available a brush rigging for a reliable and easy-to-make excited-rotor electric machine.

Said aim is achieved by a brush holding assembly for an excited-rotor electric machine having the characteristics of one or more of the subsequent claims and, in particular, comprising a casing provided with at least two ducts flanked to each other and developing along a preferential direction between a first end and a second end, said second end being open and accessible; A pair of brushes housed and capable of sliding each in a respective duct and projecting externally to said second end; a connecting member arranged to connect with an electric current generation unit associated with said casing at said first end of the ducts.

According to an aspect of the present invention, the brush holding assembly comprises presser members associated with the brushes and configured to push said brushes in the direction of the second end in order to keep them pressed on the respective tracks of a rotating manifold of a rotor and at least two conductive elements each developing along the preferential direction of a respective duct, interposed between the respective brush and said connecting member and configured to deform along said preferential direction in order to follow the movement of the brush imparted by the presser members.

Advantageously, in this way it is possible to compensate the brush wear while maintaining the connection efficiency and without reducing reliability.

Preferably, moreover, each of the conductive elements are defined by a wire or rope (in copper) developing between the respective brush and the connecting member.

Alternatively (or jointly), each of the conductive elements comprise a spring-shaped elastically deformable section along said preferential direction.

These and other features, with the relative advantages, will become more apparent from the subsequent exemplary, therefore not limiting, description of a preferred, therefore not exclusive, embodiment of a brush holding assembly for an excited-rotor electric machine according to what illustrated in the appended figures, wherein:

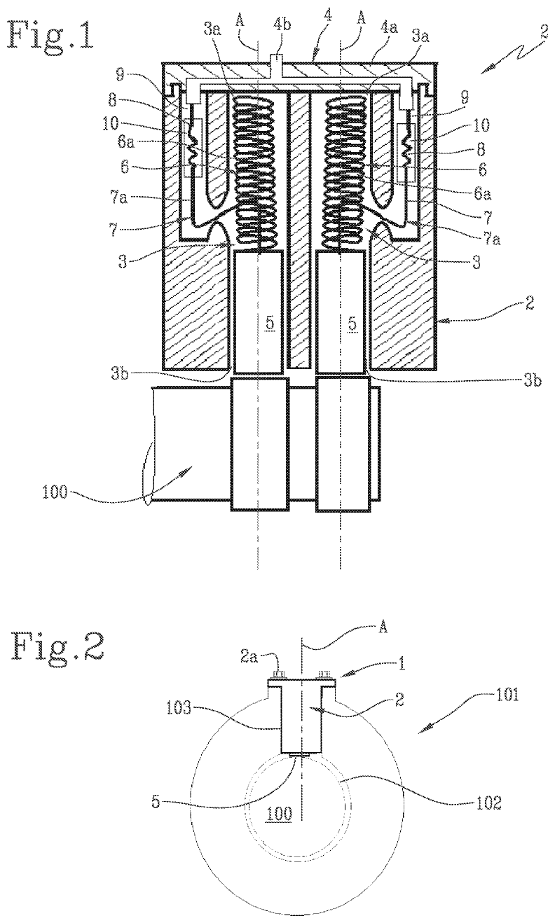

FIG. 1 schematically shows a brush holding assembly according to the present invention;

FIG. 2 schematically shows a contact chamber 101 for an excited-rotor electric machine comprising the brush holding assembly of FIG. 1;

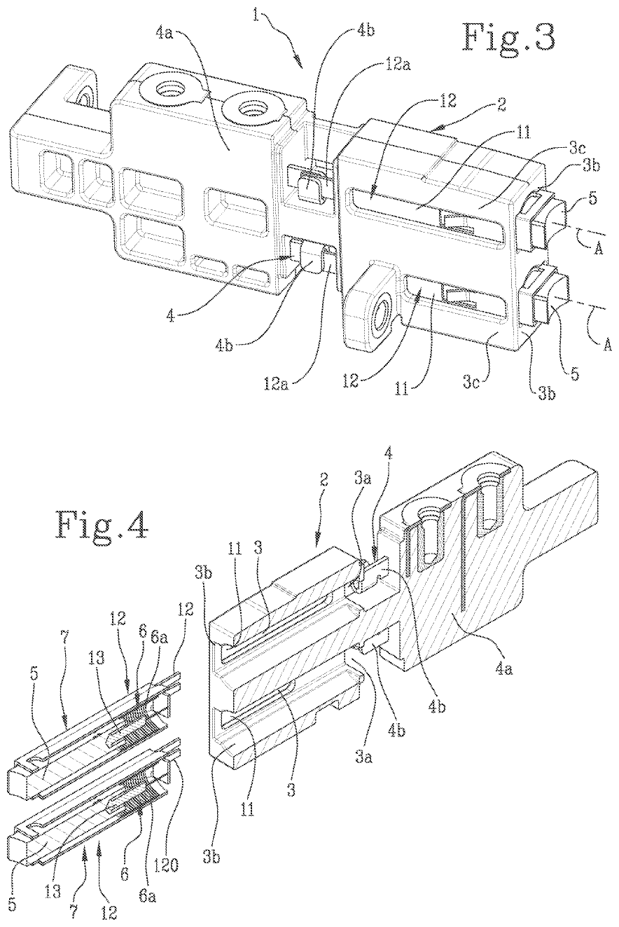

FIG. 3 show a perspective view of a further embodiment of a brush holding assembly according to the present invention;

FIG. 4 shows a longitudinal sectional view of the brush holding assembly of FIG. 3.

With reference to the appended figures, with number 1 reference is made to a brush holding assembly for an excited-rotor electric machine according to the present invention.

Said brush holding assembly 1 comprises a casing 2 provided with at least two ducts 3 mutually flanked to each other and developing along a preferential direction “A” between a first end 3a and a second end 3b.

Preferably, the second end 3b is open and accessible along the preferential direction “A”.

More preferably, also the first end 3a is open and connected to an electrical connecting member 4.

Said connecting member 4 is therefore associated with the casing 2 at the first end 3a of the ducts 3 and is arranged to connect with an electric current generation unit (not illustrated).

In this light, the connecting member 4 preferably comprises at least one conductive element 4b (preferably two) configured to transmit the electric current energy generated by the generating unit.

The conductive element 4b may be, for example, be defined by a plate anchored to an insulating support 4a.

Alternatively (FIGS. 3 and 4), the conductive element is defined by a pair of plate connectors.

In the preferred embodiment, in fact, the electrical connecting member 4 comprises an insulating support 4a shaped like a plug (or the like) and selectively coupled, preferably with fast connection means, to the first end 3a of the duct to occlude it.

Inside each duct 3, a brush 5 is provided suitable for transmitting the current coming from the connecting member 4, by sliding contact, to a rotor manifold 100.

It should be noted that the term “brush” refers to both filament brushes and, preferably, bar-shaped brushes having a rectangular cross-section and made of materials such as, for example, high density carbon or graphite impregnated with high electrical conductivity metal.

Each brush 5 is housed capable of sliding (along the preferential direction “A”) in the respective duct 3 of the casing 2 and is positioned so as to be (even imperceptibly when in contact with the manifold) externally projecting from the second end 3b in order to sliding contact the manifold 100.

Preferably, the casing 2 has at least one through opening 11 made at a side wall 3c of each duct 3 in order to increase the heat exchange.

More preferably, said through openings 11 have longitudinal development along said preferential direction and run along the brushes 5.

In the illustrated embodiment, the casing has two through openings 11 for each duct 3.

According to an aspect of the present invention, the brush holding assembly 1 comprises presser members 6 associated with the brushes 5 and configured to push said brushes 5 towards the second end 3a in order to keep them pressed on the respective tracks of the rotating manifold.

The presser members 6 are therefore preferably housed in the duct 3, operatively interposed between the first end 3a and the brush 5.

Preferably, the support also comprises guide means suitable for keeping the movement of the brushes inside the duct 3 linear, facilitating the action of the presser members 6.

In the preferred embodiment, the presser members 6 comprise a spring 6a, preferably helical, developing between the first end 3a of the duct and the brush 5, more preferably preloaded.

Still according to the present invention, moreover, the brush holding assembly 1 comprises at least two conductive elements 7 developing along the preferential direction “A” of a respective duct 3 and each one interposed between a respective brush 5 and said connecting member 4.

Such conductive elements 7 are configured to deform along said preferential direction “A” in order to follow the movement of the brush 5 imparted by the presser members 6 (as a result of wear).

Advantageously, in this way there is no risk that the brushes 5, translating inside the duct 3, damage the connections or interrupt the connection with the connecting member 4.

Preferably, each of the conductive element 7 are defined by a loose wire or rope 7a developing between the respective brush 5 and the connecting member 4.

Alternatively (or jointly), the conductive element 7 comprises a elastically deformable section 8 (for example spring-shaped) along said preferential direction “A”.

In some embodiments, the conductive elements 7 can be housed in the ducts 3.

Preferably, however, the casing 2 comprises a pair of auxiliary chambers 9, flanked to each other and in connection with a respective duct 3.

The conductive elements 7 are at least partially housed inside said auxiliary chambers 9 in order to avoid interference with the presser members 6.

More precisely, the conductive elements 7 develop from the respective brush (in the duct 3), continue to escape from the duct and enter the auxiliary chamber 9 and then connect to the connecting member 4.

In this regard, the shape of the transition zone between the duct 3 and the auxiliary chamber 9 is suitably shaped and free from sharp edges in order to allow the conductive element 7 (copper wire or rope or the like) to slide without damaging it.

Moreover, in some embodiments, in order to optimize the connection reducing the losses, the conductive element 7 is fixed to the connecting member 4 by means of a pressure engagement 10, more preferably reversible.

Preferably, however, the casing 2, the two brushes 5, the connecting member 4, the presser members 6 and the conductive elements 7 are co-moulded.

In this regard, a compensation chamber 10, preferably housed in the auxiliary chamber 9, is preferably provided, containing the deformable section of the wire or rope 7a.

According to a preferred variant of the present invention, the two conductive elements 7 are defined by two pre-assembled conductive cartridges 12.

Each cartridge 12 develops longitudinally along the preferential direction “A” and comprises a containment volume inside.

More precisely, the cartridge 12 is counter-shaped and engaged into the respective duct 3.

In particular, each cartridge 12 has an end 12a constrained to the connecting member 4 and contains (inside said volume) the respective brush 5, the respective presser member 6 and at least one flexible element 13 developing between a wall of said cartridge 12 and the brush 5.

In the preferred embodiment, the end 12a of the cartridge has a pin (or protrusion) which can be coupled with a terminal of the connecting member 4.

More preferably, the end 12a of the cartridge 12 is constrained to the connecting member 4 via a welding.

This allows to facilitate the mounting method of the brush holding assembly 1.

In fact, thanks to the arrangement of the cartridges 12 containing the brush 5 and the respective presser member 6 it is possible to mount the assembly 1 simply by:

arranging the casing 2;

arranging the cartridges 12;

engaging each cartridge 12 inside the respective duct 3 so that one end 12a of the cartridge 12 is abutted to said at least one connecting member 4;

coupling said end 12a with said connecting member 4 by means of welding.

Preferably, moreover, the casing 2 is provided with fixing means 2a facing outwardly thereof and shaped to allow a reversible coupling of the casing 2 itself with a housing of the manifold 100.

In this regard, preferably the brush holding assembly 1 according to the invention is used inside a contact chamber 101 for a such shaped excited-rotor electric machine.

Said chamber 101 comprises an annular housing 102 for a sliding-ring manifold 100 and a sliding-ring manifold 100 as previously described.

Preferably, the annular housing 102 comprises a receiving space 103 for the brush holding assembly 1.

Thanks to the fixing means 2a (for example by interlocking or screwing), the brush holding unit 1 (in particular the casing 2) can be reversibly coupled with the receiving space 101.

Therefore, such brush holding assembly 1 can be selectively switched, by its fixing means 2a, between a release configuration and a coupling configuration, wherein the brushes 5 result to be faced internally in the annular housing 102 and abutted to the manifold 100.

The invention achieves the intended aims and achieves important advantages.

In fact, the arrangement of a brush holding assembly provided with a deformable conductive element, together with the presence of presser members capable of maintaining contact with the manifold, maximizes the efficiency and reliability of the connection.

1. A brush holding assembly for an excited-rotor electric machine, comprising:
a casing provided with at least two ducts mutually flanked to each other and developing along a preferential direction between a first end and a second end; said second end being open and accessible;
at least two brushes housed and capable of sliding each in a respective duct and projecting externally to said second end;
a connecting member arranged to connect with an electric current generation unit associated with said casing at said first end of the ducts;
wherein it comprises:
presser members associated with the brushes and configured to push said brushes in the direction of the second end in order to keep them pressed on the respective tracks of a rotating manifold of a rotor;
at least two conductive elements developing along said preferential direction, each operatively interposed between a respective brush and said connecting member and configured to deform along said preferential direction in order to follow the movement of the brush imparted by the presser members,
wherein said casing comprises fixing means externally faced to it and shaped to allow a reversible coupling of the casing with the housing of the manifold.

2. The brush holding assembly according to claim 1, wherein said conductive elements are defined by a loose wire or rope developing between the respective brush and the connecting member.

3. The brush holding assembly according to claim 1, wherein said conductive elements comprise a spring-shaped elastically deformable section along said preferential direction.

4. The brush holding assembly according to claim 1, wherein said conductive elements are fixed to the connecting member by means of a pressure engagement.

5. The brush holding assembly according to claim 1, wherein said casing comprises a pair of auxiliary chambers, each flanked and connected to a respective duct; said conductive elements being at least partially housed inside said auxiliary chambers in order to avoid interference with the presser members.

6. The brush holding assembly according to claim 1, wherein said casing, said two brushes, said connecting member, said presser members and said conductive elements are co-moulded.

7. The brush holding assembly according to claim 1, wherein said casing has at least one through opening made at a side wall of each duct in order to increase the heat exchange.

8. The brush holding assembly according to claim 1, wherein said two conductive elements each have a conductive cartridge having an end constrained to said connecting member and containing the respective brush, the respective presser member and at least one flexible element developing between a wall of said cartridge and the brush.

9. A contact chamber for an excited-rotor electric machine, comprising:
an annular housing for a sliding-ring manifold;
a sliding-ring manifold inserted with the possibility of rotation within said housing;
wherein said annular housing comprises a receiving space of a brush holding assembly according to claim 7; said brush holding assembly which can be reversibly coupled to said receiving space in order to be selectively switched, through its fixing means, between a release configuration and a coupling configuration, wherein the brushes are faced internally to the annular housing and abutted against the manifold.

10. A method for mounting a brush holding assembly for an excited-rotor electric machine, comprising the steps of:
arranging a casing provided with at least two ducts mutually flanked to each other and developing along a preferential direction between a first end and a second endue; said casing further comprising at least one connecting member arranged to connect with an electric current generation unit and at least partially placed at said first end of the ducts;
arranging a pair of conductive cartridges each containing a respective brush, a respective presser member and at least one flexible element developing between a wall of said cartridge and the brush;
engaging each cartridge inside the respective duct so that one end of the cartridge is abutted to said at least one connecting member;
coupling said end with said connecting member by means of welding.
